(19) United States
(12) Patent Application Publication
(10) Pub. No.: US 2010/0018128 A1
(43) Pub. Date: Jan. 28, 2010

(54) GUTTER

(75) Inventors: Wolfgang Strandi, Aichach (DE); Xaver Berger, Aichach (DE)

Correspondence Address: MCNEES WALLACE & NURICK LLC, 100 PINE STREET, P.O. BOX 1166, HARRISBURG, PA, 17108-1166, US

(73) Assignee: MEA BAUSYSTEME GMBH, Aichach, DE (DE)

(21) Appl. No.: 12/373,420

(22) PCT Filed: May 15, 2008
(86) PCT No.: PCT/EP07/08066

§ 371 Date: Jul. 29, 2009

(30) Foreign Application Priority Data
Nov. 10, 2006 (DE) 10 2006 053 345.3

(51) Int. Cl. E04D 13/064; F16B 1/00; E04D 13/00; E04C 2/42; E04D 13/068

(52) U.S. Cl. 52/12; 411/77; 52/11; 52/660

(57) ABSTRACT

The invention relates to the securing of a grid to a gutter. The invention further relates to a gutter, a grid, and a system comprising a gutter, a grid, and a securing mechanism. Also disclosed is a method for producing the gutter according to the invention.

The present invention relates to the securing mechanism for securing a grating on a gutter. The present invention also relates to a gutter, to a grating and to a system comprising the gutter, grating and securing mechanism. The present invention further relates to a method of producing the gutter according to the invention.

Gutters, in particular those made of plastic, are known from the prior art and are used, for example, for channeling away surface water. These gutters usually have, for covering purposes, a grating which has to be secured on the gutter so that lifting is prevented. The currently known mechanisms for securing the grating on the gutter, however, have the disadvantage that they involve comparatively high outlay to produce and to fit and that they have certain disadvantages in use.

It has therefore been an object of the present invention to provide a securing mechanism which does not have the disadvantages of the prior art.

The object is achieved by a securing mechanism for securing a grating on a gutter in which the securing mechanism has a wedging means which forces two legs of the securing mechanism apart from one another and thus produces a form fit and/or force fit between the securing mechanism and the grating.

The securing mechanism according to the invention has the advantage that it can be fitted without a screwdriver or the like. All that is required is for the wedge to be introduced between the two legs in order for the latter to be forced apart from one another.

The wedging means preferably has a plurality of latching means which interact in latching fashion with latching means which are arranged on the legs.

According to a further, or a preferred, subject matter of the present invention, the securing mechanism has a U-shaped securing means which interacts in a form-fitting and/or force-fitting and releasable manner with an aperture which is located in the gutter.

A respective latching nose is preferably arranged on the legs of the U-shaped securing means, and this latching nose interacts in latching fashion with a corresponding counterpart in the aperture of the gutter. This results in a fixed connection, which can nevertheless be released, if a certain level of force is applied, without the securing mechanism or the gutter being damaged.

The U-shaped securing means and the legs are preferably arranged at right angles to one another. This preferred embodiment of the securing mechanism according to the invention has the advantage that the securing mechanism is more robust overall, and that the securing mechanism can be released from the gutter without warping

The present invention also relates to a gutter, in particular made of plastic, with a metal edge, the metal edge being connected in a form-fitting and/or force-fitting manner to the gutter.

The gutter according to the invention has the advantage that the metal edge need not be encapsulated by the plastic. This significantly simplifies the production of the gutter, and use can be made of the same mold for producing a gutter with or without a metal edge.

The metal edge preferably has connecting legs which bring about the force-fitting connection.

A further preferred subject matter of the present invention, or a subject matter according to the invention, is constituted by a gutter which has fastening and covering means, in which case a lateral connection part can be fitted on the gutter.

This embodiment of the gutter according to the invention, or this preferred embodiment of the gutter, has the advantage that a lateral gutter, a lateral pipe or the like can optionally be fitted on the gutter. This means that the preferred gutter, or the gutter according to the invention, can be used in a very flexible manner, and fewer parts have to be kept in stock.

The gutter and the lateral connection part are preferably connected via a connecting element which can be fitted, particularly preferably, in a form-fitting, force-fitting and/or integral manner on the gutter.

This connecting element can preferably be connected to a gutter or a pipe. This embodiment of the present invention has the advantage that the gutter can be configured in a very flexible manner in accordance with the respective requirements.

The connecting element preferably has securing noses, in order to prevent the gutter/gutter or gutter/pipe connection from being released.

The present invention further relates to a grating for positioning on a gutter, the grating having apertures by means of which a securing mechanism for preventing lifting is enclosed around the periphery of said gutter.

Preferably, or according to the invention, the grating has a securing nose which prevents longitudinal displacement and is arranged such that it interacts with the same aperture in the gutter with which the securing mechanism for preventing lifting also interacts. This preferred embodiment of the grating according to the invention has the advantage that just one aperture has to be arranged in the gutter for the securing mechanism for preventing lifting and for the securing mechanism for preventing longitudinal displacement of the grating. The gutter is thus more straightforward to produce and has a greater level of stability.

The grating preferably has, in addition, a securing nose for preventing transverse displacement of the securing mechanism. This preferred embodiment of the grating prevents the situation where the securing mechanism slips out of the aperture of the gutter and the securing mechanism for preventing lifting of the grating is therefore released. Furthermore, the securing mechanism is protected by the securing nose of the grating during transportation.

The present invention additionally relates to a system comprising a gutter, grating and securing mechanism, the securing mechanism having bearing surfaces which project out of the bearing surface of the grating, and the grating resting on these bearing surfaces, rather than itself resting on the gutter. The system according to the invention has the advantage that the amount of noise developed for example as a result of a car traveling over the grating is reduced.

The present invention additionally relates to a method of producing the gutter according to the invention, in the case of which the metal edge is positioned on the gutter and the connecting legs are deformed to give a form-fitting and/or force-fitting connection.

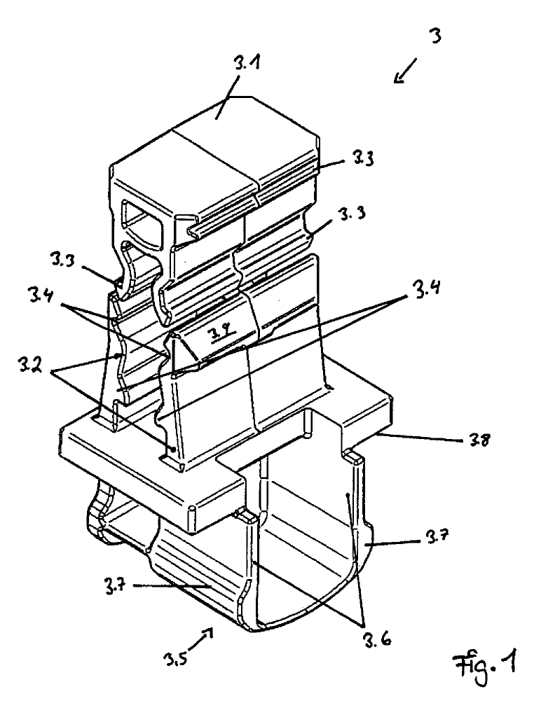

The invention will be explained hereinbelow with reference to FIGS. 1-12. These explanations are given merely by way of example and do not restrict the general idea of the invention. The explanations apply equally to all the subjects of the present invention.

FIG. 1 shows the securing mechanism according to the invention.

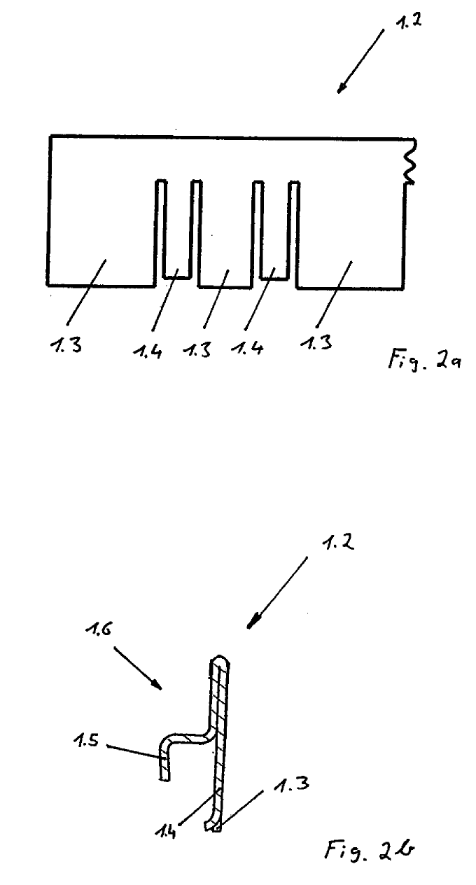

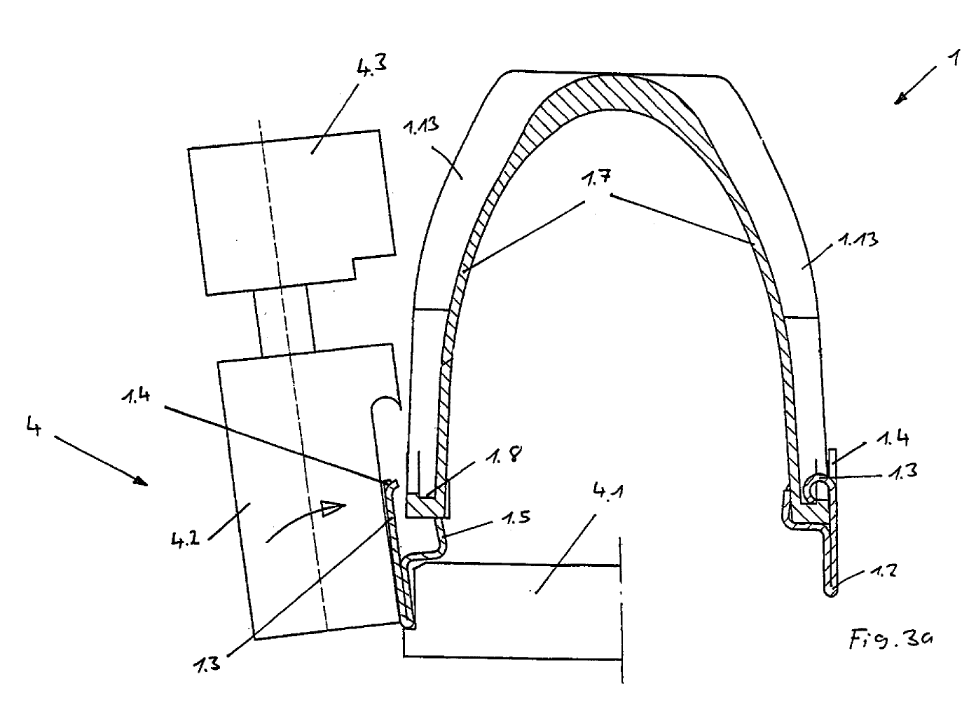

FIGS. 2a and 2b show the metal edge of the gutter.

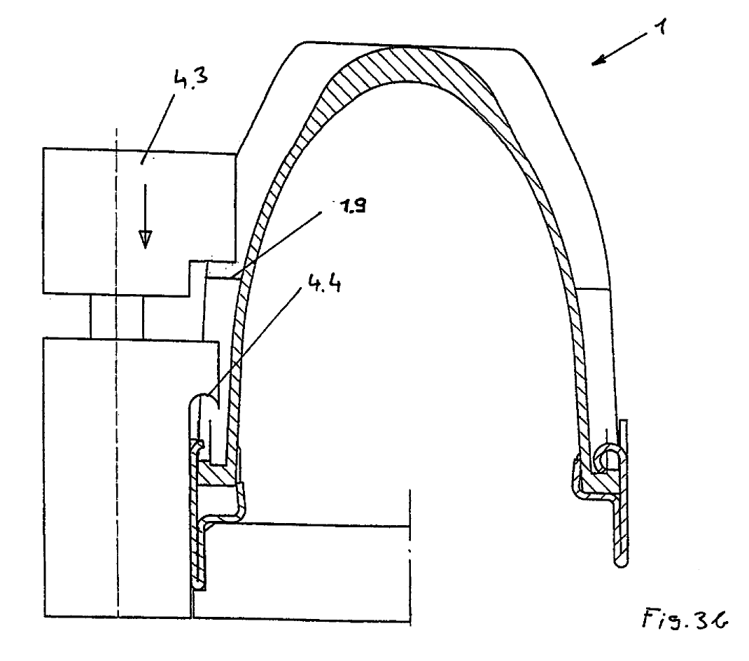

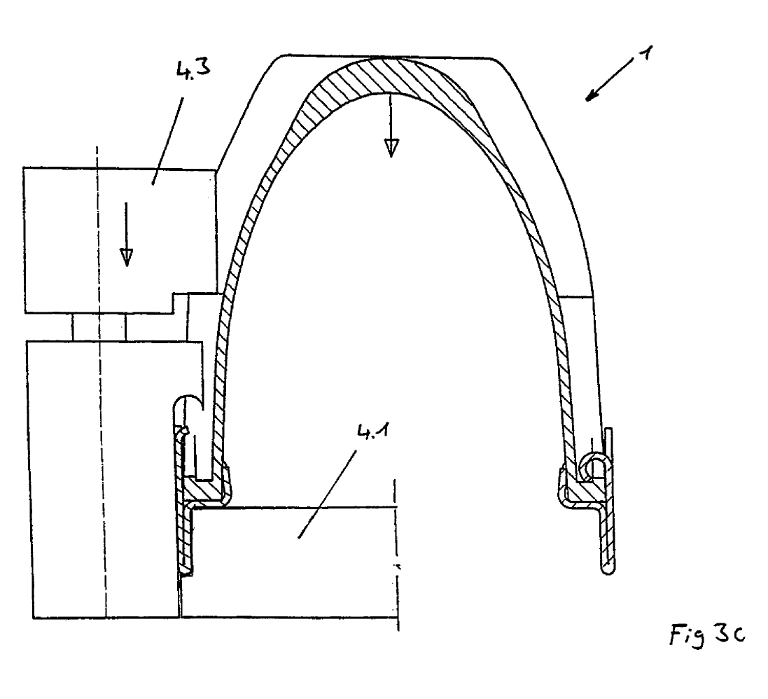

FIGS. 3a-3d show the method of fitting the metal edge on the gutter.

FIG. 4 shows the metal edge fitted on the gutter.

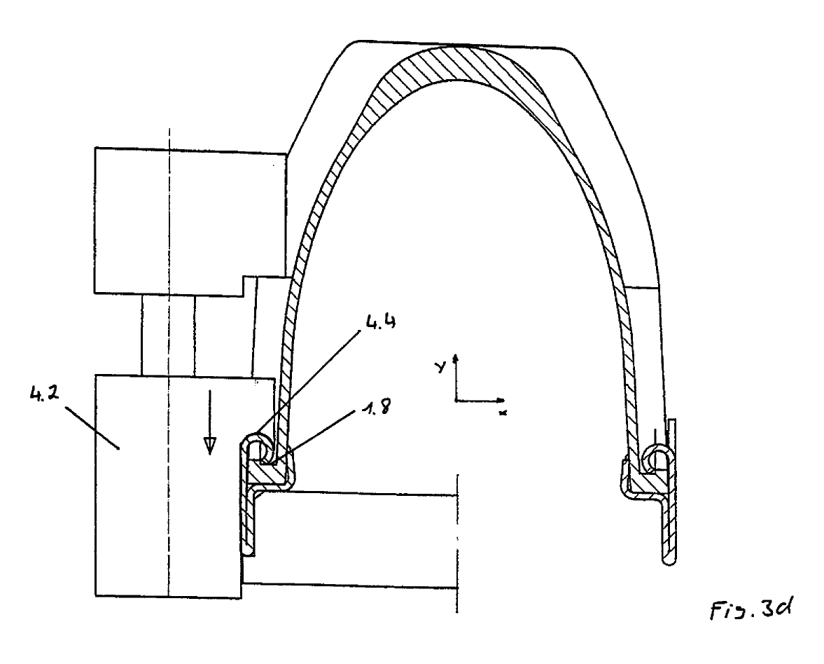

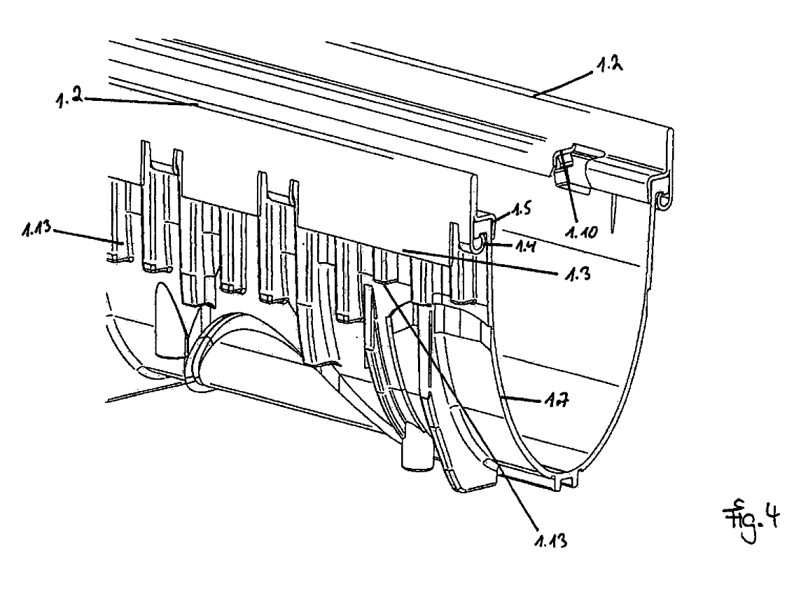

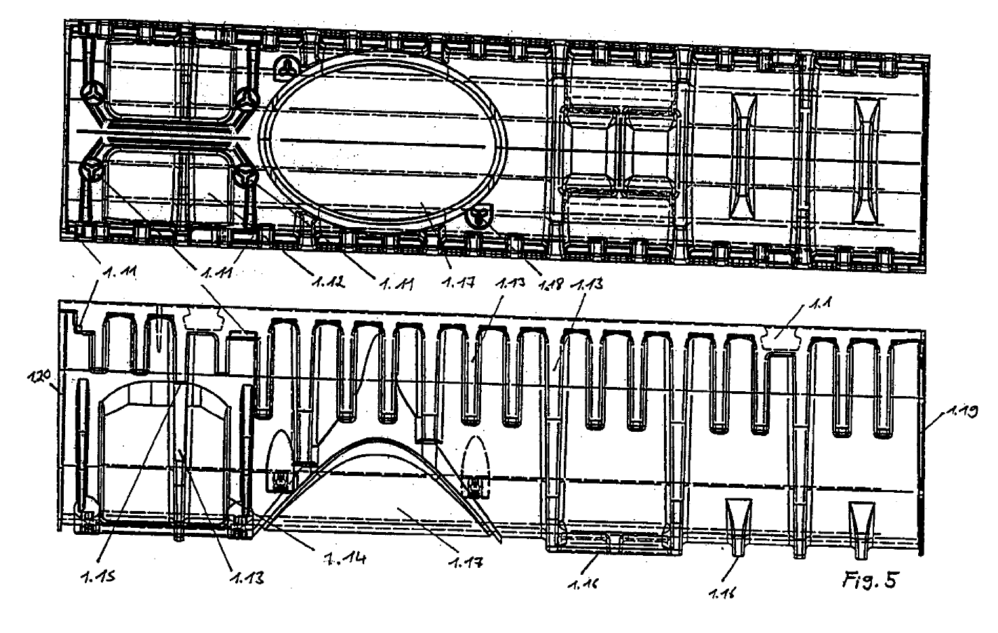

FIG. 5 shows two views of the gutter according to the invention.

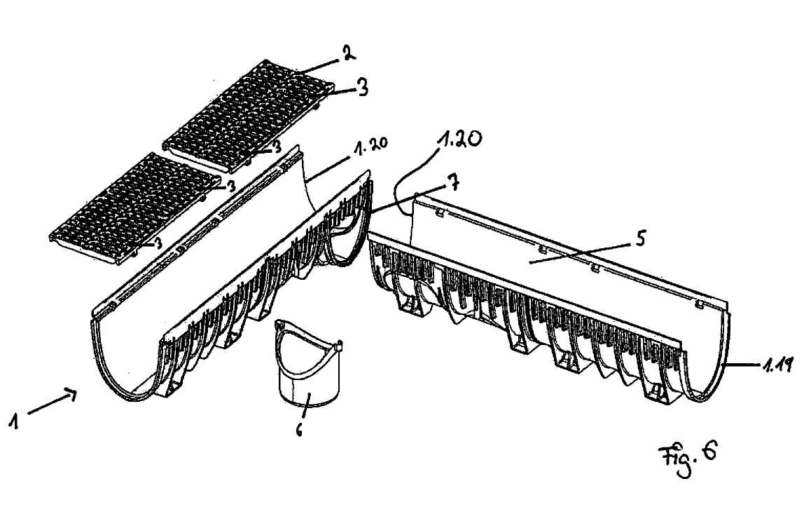

FIG. 6 shows two gutters which are arranged at right angles to one another.

FIG. 7 shows the connecting element between two gutters or a gutter and a pipe.

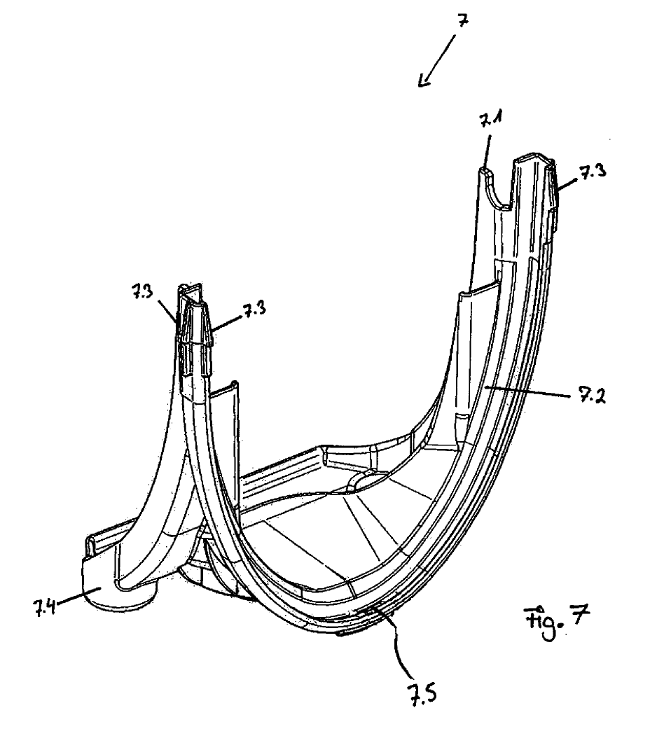

FIG. 8 shows the gutter with a lateral pipe connection.

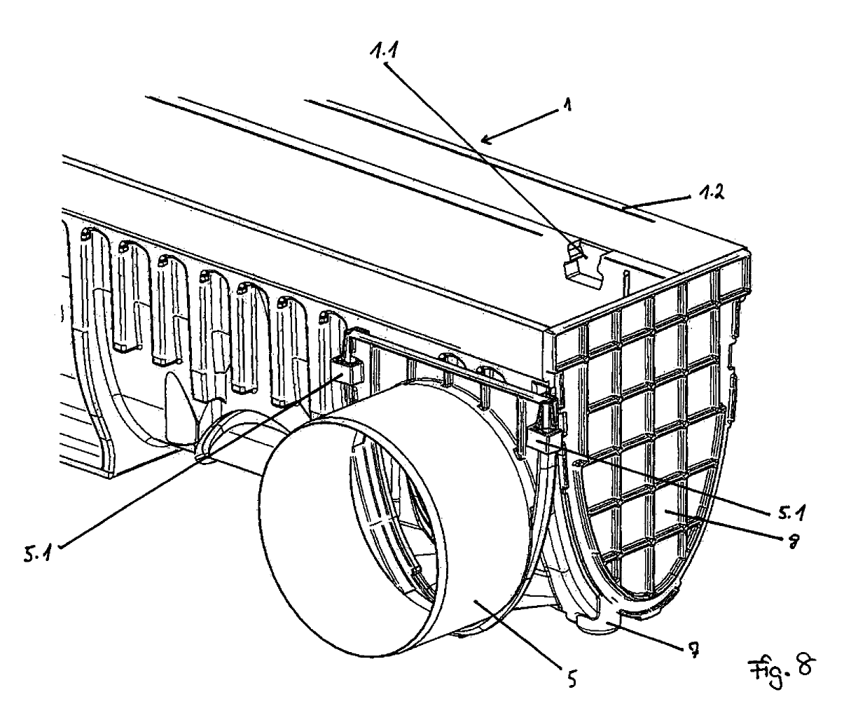

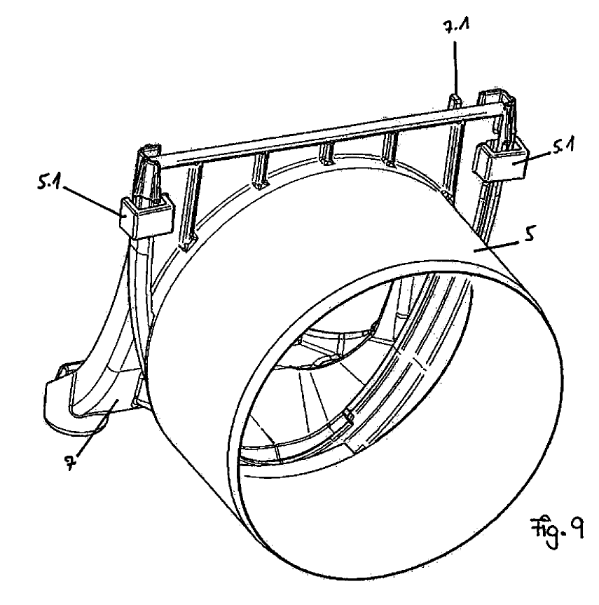

FIG. 9 shows a detail of the pipe connection according to FIG. 8.

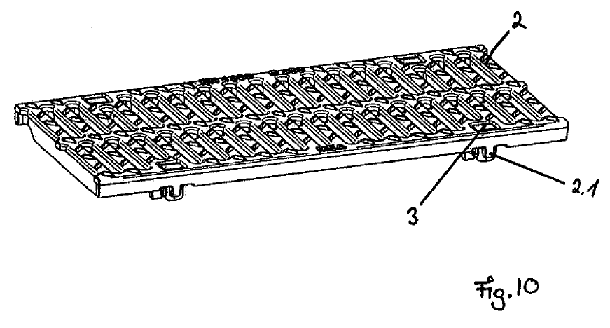

FIG. 10 shows the grating according to the invention.

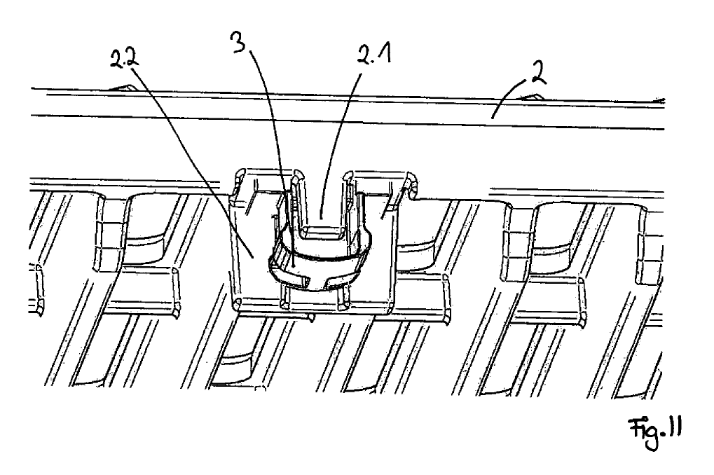

FIG. 11 shows a detail of the grating according to the invention.

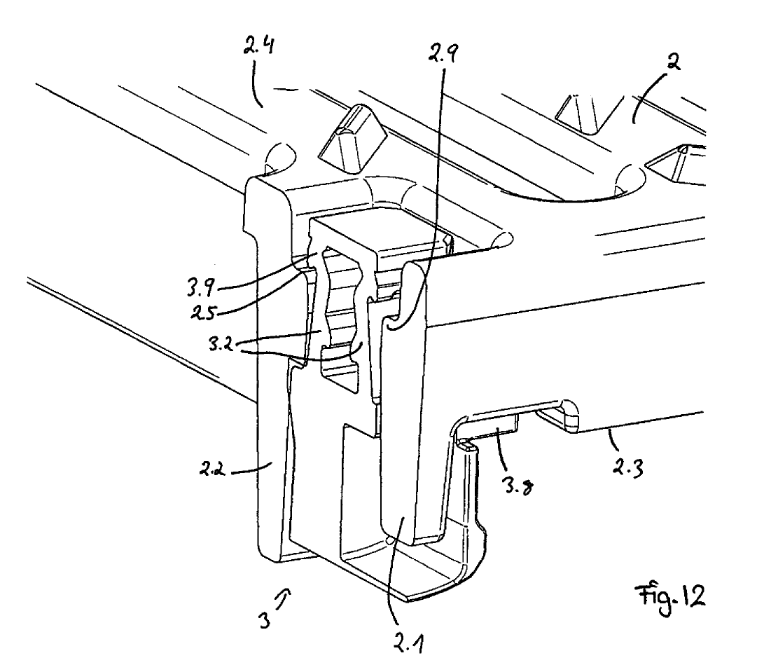

FIG. 12 shows a further detail of the grating according to the invention.

FIG. 1 shows the securing mechanism 3 according to the invention, which comprises a wedging means 3.1 and a U-shaped securing means 3.5. The securing mechanism 3 and the grating 2 (not illustrated) are connected by the U-shaped securing means being plugged into an aperture in the grating from beneath. The wedging means 3.1 is then plugged in between the legs 3.2 from above until all the latching means 3.3 of the wedging means 3.1 engage in latching fashion with the latching means 3.4 of the legs 3.2. This fitting operation can be done using simple tools, for example a hammer. Since the wedging means 3.1 is driven between the legs 3.2, the legs are bent outward, in which case the latching nose 3.9 engages with corresponding protrusions arranged on the grating 2. This produces a form-fitting and/or force-fitting and non-releasable connection between the securing mechanism 3 and the grating 2. Furthermore, the securing mechanism according to the invention has the legs 3.6 of the U-shaped securing means at its bottom end. On the one hand, these legs are configured to be flexible enough to be bent inward from the outside under pressure. In addition, they have, on their outside, latching noses 3.7 which interact in latching fashion with corresponding protrusions in a corresponding aperture in the gutter. The base of the U-shaped securing means, which connects the two legs 3.6 to one another, is curved downward slightly, in which case the legs 3.6 can be forced together in the inward direction, but there is also a certain level of prestressing prevailing which forces the legs 3.6 outward, as a result of which a form fit and/or force fit is constantly maintained between the securing mechanism and the gutter. The legs 3.6, the base which connects the two legs and the aperture in the gutter are configured such that the connection between the securing means 3.5 and the gutter 1 can be released with a certain level of force being applied, without the securing mechanism or the gutter being damaged. The legs of the U-shaped securing means 3.6 are arranged at right angles to the legs 3.2. This embodiment of the securing mechanism according to the invention has the advantage that the legs 3.2 do not warp when the securing mechanism is released from the gutter, and the component is configured to be more robust overall under this loading. The legs 3.2 are enclosed by the grating on four sides, in which case the securing mechanism is very well protected against mechanical influences. Furthermore, it is also the case that the top side of the wedging means 3.2 does not project out of the grating, as a result of which this top side of the wedging means also cannot be damaged by a vehicle for example traveling over the grating. The securing mechanism according to the invention has a bearing surface 3.8 which projects out of the bottom plane 2.3 of the grating (of FIG. 12) and rests on the gutter. The grating itself therefore does not usually rest on the gutter, which has a positive effect for example when a motor vehicle travels over the grating.

FIGS. 2a and 2b show the metal edge 1.2 which is fitted at the top ends of the gutter in each case. This metal edge 1.2 is produced from a metal sheet by bending and has abutment legs 1.3, 1.5 and connecting legs 1.4. As can be seen from the following figures, the abutment leg 1.5 interacts with the inside of the gutter, while the abutment leg 1.3 butts against the outside of the gutter. The connecting leg 1.4 is pre-bent slightly at its bottom end in order to make it easier for the metal edge to be fitted subsequently on the gutter. The abutment and/or bearing means 1.6 serves for positioning the grating or the securing mechanism on the gutter.

FIGS. 3a to 3d show the operation of fitting the metal edge on the gutter according to the invention. The latter has two legs 1.7, which together form essentially a V shape, U shape or parabola shape. The legs of the gutter 1.7 are reinforced by a plurality of ribs 1.13 arranged in the longitudinal direction of the gutter. At the ends of the two legs, the gutter, in the present case, has a respective abutment surface for a metal edge. A person skilled in the art is aware that the gutter according to the invention need not necessarily have a metal edge; rather, corresponding abutment surfaces for the grating which is to be placed in position may also be formed in the legs. Furthermore, a person skilled in the art will understand that the gutter is up-ended in FIGS. 3a to 3d. Whereas the right leg 1.7 of the gutter according to the invention has already been connected in a form-fitting and/or force-fitting manner to a metal edge 1.2, the left leg of the gutter will be used to explain the operation of fitting the edge 1.2 on the gutter. For this fitting operation, it is necessary to use a tool 4 comprising an abutment 4.1 and a forming tool 4.2 and a slide 4.3. First of all, the metal edge 1.2 is positioned on the abutment 4.1 and then, as is illustrated by the arrow, it is forced inward by the forming tool 4.2 until the leg 1.5 is located on the inside of the leg 1.7 of the gutter. This state is illustrated in FIG. 3b. As soon as this has taken place, the slide 4.3 is forced downward until it butts against the surface 1.9 of the gutter 1. The movement of the slide 4.3 is likewise depicted by an arrow. Then, as is illustrated in FIG. 3c, the gutter as a whole is forced downward by the slide 4.3 until the leg 1.7 of the gutter butts, in its entirety, against the metal edge 1.2. Finally, the forming tool 4.2 is also moved downward, in which case the pre-formed connecting leg 1.4 is deformed in the form of an arc of a circle until it butts against the recess 1.8 of the legs 1.7. This results in a form fit and/or force fit both in the X direction and in the Y direction. Furthermore, the abutment leg 1.5 is prestressed slightly by the forming of the connecting leg 1.4. This method of connection is carried out at a number of locations along the longitudinal direction of the gutter. The form-fitting and/or force-fitting connection between the metal edge and the gutter takes place at a number of locations simultaneously.

FIG. 4 shows the gutter according to the invention. Whereas, on the left leg, the form-fitting and/or force-fitting connection between the metal edge 1.2 and the leg 1.7 of the gutter 1 has already taken place, this operation still has to be carried out on the right leg. It can be seen from this view that there are a plurality of form-fitting and/or force-fitting connections between the metal edge 1.2 and the gutter 1 along the longitudinal direction of the gutter. It can also be seen from this view that the bearing surface 1.6 for the grating/securing mechanism has been cut away at the locations at which the securing mechanism 3 engages in the gutter 1.

FIG. 5 shows the gutter 1 according to the invention in a view from beneath and in a view from the side. The gutter has in each leg, at its left-hand end and at its right-hand end (not illustrated), a respective covering means 1.12 which can optionally be removed in order for it to be possible for further connection gutters or pipes to be arranged laterally on the gutter. A predetermined breaking edge 1.14 is arranged between the covering means 1.12 and the gutter, and the covering means 1.12 is separated from the gutter 1 along this edge. Before this can take place, the rib 1.13, which is located in the region of the covering means 1.12 and ensures that the latter is sufficiently stable, has to be severed along the interface 1.15. The covering means 1.12 can then be straightforwardly removed. Furthermore, the gutter according to the invention has, for each leg, four fastening means 1.11 which can be used to fasten a connecting element 7 (not illustrated) on the gutter. In the top region of the legs, these connecting means are apertures, into which pins 7.1 can be introduced. In the bottom region of the legs, the fastening means 1.11 are cylinders or cones, over which a cylindrical or conical connecting element 7 is plugged and can then be fastened thereon. Furthermore, the gutter according to the invention has a further covering means 1.17. This covering means 1.17 can optionally be removed in order to realize a vertical discharge from the gutter. Also arranged in the region of the covering means 1.17 are fastening means 1.18, in order for the vertical pipe to be fastened on the gutter. In the installed state, the gutter stands on bearing surfaces 1.16. At one end, the gutter according to the invention has a groove and, at its other end, it has a tongue. The tongue of the one gutter is plugged into the groove of the other gutter in order for it to be possible for these gutters to be connected to one another to give any desired length. In the region of the groove and of the tongue, the gutter according to the invention has sealing surfaces which, following installation of the gutter in the ground, can be sealed to an extent sufficient for it also to be possible for the gutter according to the invention to be used in the region of gas stations and the like. It is also the case that the connection to the lateral and/or vertical pipes or gutters is configured such that it can be sealed in retrospect.

FIG. 6 shows the system according to the invention comprising a gutter 1 and the grating 2, which can be fastened on the gutter 1 in each case by way of four securing mechanisms 3 (only two of which are illustrated). Furthermore, the gutter 1 has a lateral 90° branched portion 5, which is connected to the gutter via the connecting element 7. The pipe 6, which is likewise connected to the gutter 1, leads vertically downward.

FIG. 7 shows the connecting element 7. The latter has, on its left and right legs, a respective connecting means 7.1 which is pushed in each case into an aperture in the gutter. The connecting means 7.4 here are pushed onto the cylinders 1.1. Either these connecting means 7.4 can be connected to the cylinders 1.1 by a friction fit or there is a further fastening means, for example a screw, present which connects the connecting means 7.4 to the cylinder 1.1. The connecting element 7 also has a groove 7.2, into which a lateral connection part can be introduced. In the bottom region, the groove has a slot 7.5, which accommodates a protrusion of the lateral connection part 5 and secures the latter in the groove. Also arranged on each leg, in the region of the groove, are securing noses, which likewise prevent the lateral connection part from slipping out of the groove. The connecting element according to the invention is configured such that the connection between the connecting element and the lateral connection part can be fully sealed by a sealant in retrospect.

In FIG. 8, the lateral connection part is a connection pipe 5. This connection pipe 5 is arranged on an adapter plate which has been introduced into the groove 7.2 of the connecting element 7. The retaining means 5.2, which in the present case are of U-shaped configuration, interact with the securing noses 3. The U-shaped configuration of the retaining means also ensures that the legs of the connecting element do not bend outward. In the present case, the end side of the gutter 1 is closed off by a cover 8, which has stiffening ribs in order to avoid bowing of the cover.

FIG. 9 shows an enlarged illustration of the connecting element 7 and the lateral pipe. It can clearly be seen that the U-shaped retaining means 5.1 engage around the legs of the connecting element 7 in each case, and that these are located beneath the securing noses 7.3, in which case the lateral connection pipe can be prevented from sliding upward. The securing noses are arranged with an offset of 90° on the legs of the connecting element.

FIG. 10 shows the grating 2 according to the invention, which is fastened on the gutter by way of four securing mechanisms 3. In the region of the securing mechanism 3, the grating according to the invention has a respective securing nose 2.1, which engages in the aperture 1.1 in the gutter. Since the securing mechanism 3 and the securing nose 2.1 interact with the same aperture 1.1 in the gutter 1, the production thereof is more straightforward and the gutter as a whole is more stable.

FIG. 11 shows a view, in detail form, of the grating 2 in the region of the securing mechanism 3; the securing nose 2.1 for preventing longitudinal displacement is clearly visible. It can also be seen that the grating 2 has a further securing nose 2.2 behind the securing mechanism 3. This securing nose prevents the securing mechanism 3 from being displaced transversely to the longitudinal axis of the gutter, and thus prevents the release of the securing mechanism between the grating and gutter. Furthermore, the nose protects the securing mechanism as the grating is being transported.

FIG. 12 shows a further illustration of the grating 2 and of the securing mechanism 3 in detail form. It can clearly be seen that the legs 3.2 are enclosed on four sides by the grating, and that the top side of the wedging means 3.1 does not project out of the top plane 2.4 of the grating. The latching noses 3.9 interact in a form-fitting and/or force-fitting manner with corresponding protrusions 2.5 of the grating. The bearing surface 3.8 projects out of the bottom plane 2.3 of the grating, in which case these surfaces, rather than the grating itself, rest on the gutter.

### LIST OF DESIGNATIONS

1. Gutter
1.1 Aperture in the gutter for the securing means
1.2 Metal edge
1.3 Abutment leg
1.4 Connecting leg
1.5 Abutment leg
1.6 Abutment and/or bearing means for the grating
1.7 Leg of the gutter
1.8 Recess
1.9 Abutment surface
1.10 Cutout
1.11 Fastening means
1.12 Covering means
1.13 Rib
1.14 Predetermined breaking edge
1.15 Interface
1.16 Bearing surface
1.17 Covering means
1.18 Fastening means
1.19 Groove
1.20 Tongue
2. Grating
2.1 Securing nose for preventing longitudinal displacement
2.2 Securing nose for preventing transverse displacement of the securing mechanism
2.3 Bottom grating plane
2.4 Top grating plane
2.5 Protrusion
3. Securing mechanism
3.1 Wedging means
3.2 Leg
3.3 Latching means
3.4 Latching means
3.5 U-shaped securing means
3.6 Leg of the U-shaped securing means
3.7 Latching nose
3.8 Bearing surface
3.9 Latching nose
4. Fitting tool
4.1 Abutment
4.2 Forming tool
4.3 Slide
4.4 Mold
5. Lateral connection part, connection gutter, connection pipe
5.1 Retaining means
6. Vertical connection part
7. Adapter
7.1 Connecting means
7.2 Groove
7.3 Securing nose
7.4 Connecting means
7.5 Slot
8. Cover

1. A fastening mechanism for securing a grating on a gutter characterized in that the securing mechanism has a wedging means which forces two legs of the securing mechanism apart from one another and thus produces a form fit and/or force fit between the securing mechanism and the grating, and in that it has a U-shaped securing means which interacts in a form-fitting and/or force-fitting and releasable manner with an aperture in the gutter.

2. The fastening mechanism of claim 1, characterized in that the wedge has a plurality of latching means which interact in latching fashion with latching means of the legs of the securing mechanism.

3. The fastening mechanism of claim 2, characterized in that a respective latching nose is arranged on the legs of the securing means.

4. The fastening mechanism of claim 2, characterized in that the U-shaped securing means and the legs of the securing mechanism are arranged at right angles to one another.

5. A gutter, in particular made of plastic, with a metal edge, characterized in that the metal edge is connected in a form-fitting and/or force-fitting manner to the gutter.

6. The gutter of claim 5, characterized in that the metal edge has connecting legs which bring about the force-fitting connection.

7. The gutter preferably of claim 5, characterized in that it has fastening means and covering means, in which case a lateral connection part can be fitted.

8. The gutter of claim 7, characterized in that the gutter and the lateral connection part are connected via a connecting element.

9. The gutter of claim 8, characterized in that the connecting element can be connected to a gutter or a pipe.

10. The gutter of claim 8, characterized in that the connecting element has securing noses.

11. A grating for positioning on a gutter, characterized in that it has apertures by means of which a securing mechanism for preventing lifting is enclosed around the periphery of said gutter.

12. The grating of claim 11, characterized in that it has a securing nose which prevents longitudinal displacement and is arranged such that it interacts with the same aperture of the gutter in which the securing mechanism also engages.

13. The grating of claim 11, characterized in that it has a securing nose for preventing transverse displacement of the securing mechanism, and/or in that the securing nose protects the securing mechanism against damage as the grating is being transported.

14. A system comprising a gutter, grating and securing mechanism, characterized in that the securing mechanism has bearing surfaces which project out of the bearing surface of the grating, and in that the grating rests on the gutter by way of these bearing surfaces.

15. A method of producing the gutter claim 5, characterized in that the metal edge is positioned on the gutter and the connecting legs are deformed to give a form-fitting and/or force-fitting connection.
